(19) United States
(12) Patent Application Publication
(10) Pub. No.: US 2008/0147513 A1
(43) Pub. Date: Jun. 19, 2008

(54) ELECTRONIC EMBEDDED PROCEEDS ALLOCATION SYSTEM

(76) Inventor: Horace Gaynor, Bowie, MD (US)

Correspondence Address: DEWEY & LEBOEUF LLP;(PREVIOUSLY DEWEY BALLANTINE LLP), 975 F Street, NW, Washington, DC, 20004, US

(21) Appl. No.: 11/958,542

(22) Filed: Dec. 18, 2007

Related U.S. Application Data
(60) Provisional application No. 60/875,370, filed on Dec. 18, 2006.

(51) Int. Cl. G06Q 30/00; G06Q 40/00

(52) U.S. Cl. 705/26; 705/39

(57) ABSTRACT

An electronic commerce system is provided that automatically allocates the transactional proceeds to predetermined registered beneficiaries, particularly nonprofit or charitable organizations.

### BACKGROUND

The Internet has facilitated a wide range of electronic marketplaces. Various fixed price fixed priced electronic commerce websites may be found, including those operated by eBay®, Amazon.com®, Yahoo!®, and Froogle™. These websites allow users to buy and/or sell their products or services. In addition, other websites exist that facilitate the donation of money, goods and/or services to charitable and other non-profit or not-for-profit organizations.

There are, however, no present means for users to list products and services for sale on a website that also enables the donation of the sales proceeds to independent organizations electronically. Thus, to address the short comings of the art, the present invention has the following objectives.

### SUMMARY OF THE INVENTION

An object of the present invention relates to an electronic commerce system that facilitates commercial transactions where the proceeds are allocated automatically to predetermined registered beneficiaries, particularly nonprofit or charitable organizations.

### DETAILED DESCRIPTION OF THE INVENTION

Before describing the present invention in detail, it is to be understood that this invention is not limited to particular system or method, which can, of course, vary. It is also to be understood that the terminology used herein is for the purpose of describing particular embodiments only, and is not intended to be limiting. As used in this specification and the claims, the singular forms “a”, “an” and “the” include plural referents unless the content clearly dictates otherwise. Thus, for example, reference to “a device” may include a combination of two or more such devices.

Unless defined otherwise, all technical and scientific terms used herein have the same meaning as commonly understood by one of ordinary skill in the art to which the invention pertains. Although any methods and materials similar or equivalent to those described herein can be used in the practice for testing of the present invention, currently preferred materials and methods are described herein.

An embodiment of the present invention is a comprehensive software system that provides full functionality of an electronic marketplace. In this regard, the present invention may create a virtual electronic environment where sellers can provide products services for purchasers who are looking for immediate delivery of such products and services. The system can facilitate a fixed priced business model environment and also allow interaction between sellers and buyers to consummate the sale of any legal and ethical product. The marketplace can provide a level of flexibility that permits business to business (B2B) transactions, consumers to consumers (C2C) transactions, and business to consumers (B2C) transactions.

The software application of the present invention may allow sellers to list any products for sale and automatically donate the proceeds or a percentage of the proceeds to any organization that is registered as a beneficiary in the system. An organization can register with the electronic marketplace, and any user (seller) can elect to donate all or a part of the sale of that product to the organization.

The software application of the present invention employs a novel business model designated as a “Fixed Price Sales and Donation” business model. This new business model will allow anyone to sell a product or service and donate the proceeds or a percentage of the proceeds electronically to any registered organization. Accordingly, the present invention should facilitate the result of increased donations and the commitment of other needed resources to organizations worldwide.

Nonprofit or charitable organizations according to the invention include those entities that solicit contributions and may generally fall into one of the following four tax exempt categories: 501(c)(3), 501(c)(4) 501(c)(6), and 501(c)(19), as set forth by the Internal Revenue Code. Such entities may include organizations whose primary purposes are: charitable, religious, scientific, educational, literary, preventing cruelty to children or animals, fostering national or international amateur sports competition, or testing for public safety. In addition, political candidates, parties, and organizations are contemplated as beneficiaries.

### EXAMPLES

An example of the present invention may be described through the following application call flows that detail the major functionality of the system.

User Registration process Call flow: (1) The user opens a web browser and key in the URL of XVETI website (www.xveti.com); (2) The user decides to buy/sell the listed product. To buy/sell any product/product listing, the user is required to log-in to XVETI system; (3) The intended user does not have any account with the XVETI system and decides to register; (4) The system provides online registration functionality by means of a Register link in the home page; (5) The register link navigates to a New User Registration screen, where certain basic data related to user is captured; (6) The user enters all the compulsory information (marked with *) pertaining to him/her and proceeds with registration after agreeing to the user agreement and privacy policy listed on the registration screen; (7) the user is provided with Account Information section to create an own id and system verifies the uniqueness of the id and the user is directed to change the id if any user with the same id already exists in the system; (8) The user enters a password of his choice and conformation of the same is done through reentry; (9) The user also selects a secret question from the list provided and an appropriate answer for the same which will help in user authentication during password retrieval; (10) The user can be a Buyer or a Seller in the XVETI system; (11) Upon successful entry of data, an email is sent to the user. This mail will have a link which has to be accessed by the user to complete the registration and activation process. This feature is provided to scale down dummy ID creations.

Beneficiary Management Beneficiaries are independent entities (in most cases nonprofit and charitable organizations) that are allowed to register in the Xveti system to receive certain financial benefits in the form of donations from sellers. Call flow: (1) To access the Beneficiary functionality of the System, a user needs to be a registered and active user of Xveti; (2) To access “Beneficiary Management” section, users shall log in to Xveti and navigate to XProfile page. A link shall be provided their called “Manage Beneficiaries”. Users would click on this link to take them to “Beneficiary Management” page; (3) The available choices on the “Manage Beneficiaries” page include, “Create Beneficiary”, and “View Beneficiaries”; (4) Users can create a new Beneficiary by clicking the “Create Beneficiary” link from the “Beneficiary Management” page. The System shall accept the data defined in the Required Data Elements section of this document; (5) A Beneficiary once created can only be modified, activated or deactivated by those users who created them; (6) To activate a Beneficiary Account, a Beneficiary would need to have a valid PayPal® account and a valid email address; (7) System shall verify if the PayPal® information provided for the Beneficiary is valid; (8) System shall send an email notification to the Beneficiary's email address to validate Beneficiary's email address; (9) A user can view the list of Beneficiaries created by them by clicking on the “View Beneficiaries” link on the “Beneficiary Management” screen; (10) System shows a table showing the following the columns: Beneficiary ID, Beneficiary Organization Name, Beneficiary Address, Beneficiary last Activation/Deactivation Date, Beneficiary Status; (11) A user can click on the Beneficiary ID from the above table to view or modify Beneficiary information; (12) In the “View/Modify” page, the user can also activate or deactivate the user; (13) Once a Beneficiary is created and activated in the System, they can be searched by other Xveti users; (14) At the time of creating a Product Listing, a user can select a Beneficiary. If a Beneficiary is selected the following information is captured: A checkbox confirmation, Beneficiary ID, Product listing price percentage (This is the amount that will be donated to the Beneficiary); (15) System shall provide a Search mechanism to search Beneficiaries by a Beneficiary ID and Organization Name. Users would have the ability to do partial searches. For example, searching on organization name with value “micro %” should yield all results with organization name starting with “micro”, for example “Microsoft®, Microland®, MicroArts®, etc”; (16) After successful sale, the system shall email the seller a payment authorization link so that the seller can immediately donate proceeds to Beneficiary.

Product Listing: Call flow: (1) The user is authenticated via User ID and Password provided to the XVETI application; (2) XVETI users successfully logs into the XVETI application; (3) The user is now shown the user homepage; (4) The user is able to find the link to create a new product listing; (5) The user clicks on the link to create a new product listing; (6) The Create Product List page is shown to the user; (7) The user enters the required information for the product being listed; (8) The user also has the option of entering a Beneficiary ID and percentage of selling price that will be donated to the respective Beneficiary.

Purchase Product List: Call flow: (1) The user is authenticated via User ID and password provided to the XVETI application; (2) XVETI users successfully logs into the XVETI application; (3) The user is now shown the user homepage; (4) The user chooses a product listing based on his/her search criteria to find a Product; (5) The user is shown the Product Listing Detailed Screen; (6) The user clicks on the button ‘Purchase/Buy Product’ on the detailed Page of the Product List Screen; (7) The Purchase/Buy Product Screen is shown; (8) The user pays for the product listing.

While the invention has been described in detail and with reference to specific embodiments thereof, it will be apparent to one skilled in the art that various changes and modifications can be made therein without departing from the spirit and scope thereof Thus, it is intended that the present invention cover the modifications and variations of this invention provided they come within the scope of the claims and their equivalents.

What is claimed is:

1. An electronic commerce system comprising:
a beneficiary management module; and
a product purchasing module,
wherein said electronic commerce system enables the electronic transfer of sales proceeds to a registered, charitable organization beneficiary.

2. The system of claim 1 which further comprises a user registration module.

3. The system of claim 1 wherein the beneficiary management module further comprises a shared beneficiary database among system users.

4. The system of claim 1 wherein the beneficiary is pre-qualified as a tax exempt non profit or charitable organization under the Internal Revenue Code.

5. The system of claim 1 wherein the electronic transfer involves the allocation of sales proceeds to more than one beneficiary.

6. A method for automated allocation of electronic marketplace sales proceeds to a registered, charitable organization beneficiary.
